(19) United States
(12) Patent Application Publication
(10) Pub. No.: US 2011/0095528 A1
(43) Pub. Date: Apr. 28, 2011

(54) CONNECTOR FOR CONNECTING TO A STANDARDIZED LUER TAPER OR LUER-LOCK CONNECTION

(75) Inventor: Hans-Jurgen Forberg, Oldenburg (DE)

(73) Assignee: LOGICA MEDIZINTECHNIK GMBH, Oldenburg (DE)

(21) Appl. No.: 12/997,001

(22) PCT Filed: May 22, 2009
(86) PCT No.: PCT/EP2009/003505

§ 371 Date: Dec. 9, 2010

(30) Foreign Application Priority Data
Jun. 23, 2008 (EP) 08011322.8

(51) Int. Cl. F16L 21/035

(52) U.S. Cl. 285/374

(57) ABSTRACT

A connector (5) for connecting to a standardized Luer Taper (15) or Luer-Lock connector includes a conical region (20) for contacting a conical connecting surface (25) of the standardized Luer Taper (15) or Luer-Lock connector, and a seal (45) disposed on the conical region (20).

### CROSS-REFERENCE TO RELATED APPLICATIONS

This application is a Section 371 of International Application No. PCT/EP2009/003505, filed May 22, 2009, which was published in the German language on Dec. 30, 2009, under International Publication No. WO 2009/156025 A1 and the disclosure of which is incorporated herein by reference.

### BACKGROUND OF THE INVENTION

The present invention relates to a connection part for connection to a standardized luer connection or luer lock connection, with the features specified in the preamble of the independent claim(s).

In medical technology, often, so-called luer connections are applied for the fluid-tight connection of medical apparatus and instruments, i.e. of infusion pumps. Thereby, it is the case of cone connections, whose conical surfaces have a six percent (6%) gradient. Typically, the connection parts of these connections are manufactured from plastic by way of injection molding.

Basically, these connections have proven their worth in medical technology, however, leakages may occur under unfavorable circumstances. On the one hand, deviations of the dimensions and shape with regard to the luer cone may render a sealing bearing of the cone peripheral surfaces more difficult. A further cause of leakage may lie in rough or damaged, for example scratched peripheral surfaces of the luer cones. Moreover, the viscoelastic flow of the plastic may lead to a loosening of the luer connection and thus to leakages, which particularly occurs with longer storage times or with the delivery of apparatus with pre-connected luer connections.

In practice, one often attempts to increase the ability to seal a luer connection by way of joining together the connection parts with an increased joining force. Thereby, significantly increased tensile stresses occur within the connection pieces, in particular in that connection with the luer inner cone. The connection is often rendered unusable on account of the occurring tears or breakage.

### BRIEF SUMMARY OF THE INVENTION

It is therefore an object of the present invention to create a connection part with an improved fluid-tight connection.

The above object is achieved by a connection part with the features specified in the independent claim(s). Preferred embodiments are to be deduced from the dependent claims, the subsequent description and the drawing.

The connection part according to a preferred embodiment of the present invention is a connection part for connection to a standardized luer connection or luer lock connection, and comprises a conical region which is designed for the bearing on the conical connection surface of the standardized luer connection or luer lock connection. Thereby, a seal is arranged on the conical region. In a connection to the connection part according to the present invention, this seal therefore acts additionally to the sealing bearing of the conical region on the conical counter-bearing surface. Dimensional and shape deviations, as well as damage to the bearing surfaces of a connected luer connection or luer lock connection may be compensated with this seal, by way of it being suitably deformed.

The seal which is designed in an elastic manner, has a good restoring behavior. On connection of the connection part to a luer connection or luer lock connection (hereinafter indicated as counter-connection part), the seal furthermore prevents an unintended loosening of the connection. Moreover, a sealed connection of the connection part according to the present invention, to a counter-connection part, is given already with a slight joining force. For this reason, also a lower force effort is required for releasing the connection, and thus the danger of the connection part or the counter connection part being damaged by too great a force effort, and of the tearing and breakage locations caused by this, is significantly reduced. Moreover, the connection part and the counter-connection part, with a small joining force, have a significantly reduced tendency to jam when connecting or releasing the connection. A good restoring behavior of the elastic seal furthermore reduces the viscoelastic flow of the plastics. For this reason, a post-connection of the connection parts, such as by way of rotating or pressing the connection pieces at a later stage, is not necessary. Preferably, the conical region is designed as the peripheral surface of a truncated cone, which is designed for bearing on a luer cone. This peripheral surface thereby is not necessarily designed as a coherent surface, but may also consist of several surface sections which for example are separated from one another or segmented, by a seal designed as a sealing ring.

In a preferred design, with regard to the connection part according to the present invention, it is the case of a female connection part, since this permits a connection to a standardized male connection. With this, in particular, one may avoid a high stress in the female connection part, since no great force effort is necessary for introducing the standardized male Luer connection.

In an alternative design, with regard to the connection part according to the present invention, it is the case of a male connection part which is designed for connection to a standardized female luer connection.

The seal is further preferably designed as a sealing ring which is arranged on the conical region over the complete periphery. In particular, this sealing ring is orientated coaxially to the longitudinal axis of the conical region. In this manner, a high sealing effect may be achieved along the whole periphery of the conical regions of the connection part and counter-connection part, said regions coming to bear on one another. A rotationally symmetrical construction of the connection part in the connection region furthermore permits the simple connectability of the connection part to the counter-connection part.

In a preferred design, the seal is arranged at the free axial end of the conical region. This free axial end of the connection part comes to bear on a bearing surface of the counter-connection part, as soon as the conical regions of the connection part and the counter connection part adequately overlap. Thus one may easily ensure a releasable sealing by way of this design.

Preferably, the seal is formed of an elastomer, preferably of a silicone rubber or a thermoplastic elastomer. Such an elastic seal may be manufactured inexpensively and moreover has the advantage that this has a good restoring behavior. If thus a connection to the connection part according to the invention is released, then the sealing contour returns almost into its original shape. In this manner, a reliably sealing connection to the connection part may be effected even with a repeated exchange of the counter-connection part.

Preferably, with regard to the connection part according to the present invention, the seal is integrally formed on the conical region with a material fit. In this manner, the seal is designed as one piece or as one part with the remaining connection part. A slippage or a loss of the seal is thus effectively avoided with this. Accordingly, with the application of the connection part according to the present invention, it is not necessary to position the seal in a suitable manner or to attach the seal onto the connection part before a connection to the connection part.

In a preferred design, the connection part together with the seal is designed as a two-component injection molded part. In this manner, on the one hand one may realize a material fit connection of the seal to the conical region of the connection part in an uncomplicated manner, and on the other hand such connection parts are manufacturable in an inexpensive manner with the plastic injection molding method.

Further preferably, the connection part is part of a component with a check valve. In particular with infusion applications, components are often provided with check valves. An integration of such a check valve into a connection piece according to the present invention here offers a significant advantage. If the check valve and the connection piece are present as an integral component, then these components may be produced more economically, and are simpler to assemble as well as to handle.

Further preferably, the connection part is part of a component which is designed as an injection molded part. In medical technology and in particular in infusion technology, besides, a multitude of components are manufactured by way of injection molding. Moreover, these components often comprise luer connections or luer lock connections. If these are manufactured together with the connection part according to the invention as a single-part or single-piece component by way of injection molding, then production steps and thus also manufacturing costs may be saved. Moreover, the handling, the assembly as well as the maintenance of such single-part or single-piece components is significantly simplified.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a longitudinal section view of a connection part according to a preferred embodiment of the present invention, which is designed as a female connection part for connection to a male luer connection;

FIG. 2 is a longitudinal section view of the connection part according to FIG. 1, in a connection with a male luer connection;

FIG. 3 is a longitudinal section view of a further connection part according to a preferred embodiment of the present invention, which is designed as a female connection part for connection to a male luer lock connection;

FIG. 4 is a longitudinal section view of the connection part according to FIG. 3, in a connection with a male luer lock connection;

FIG. 5 is a longitudinal section view of a further connection part according to a preferred embodiment of the present invention, which is designed as a male connection part for connection to a female luer lock connection; and

FIG. 6 is a longitudinal section view of the connection part according to FIG. 5, in a connection with a female luer lock connection.

### DETAILED DESCRIPTION OF THE INVENTION

Certain terminology is used in the following description for convenience only and is not limiting. The words “inwardly” and “outwardly” refer to directions toward and away from, respectively, the geometric center of the device, and designated parts thereof, in accordance with the present invention. Unless specifically set forth herein, the terms “a,” “an” and “the” are not limited to one element, but instead should be read as meaning “at least one.” The terminology includes the words noted above, derivatives thereof and words of similar import.

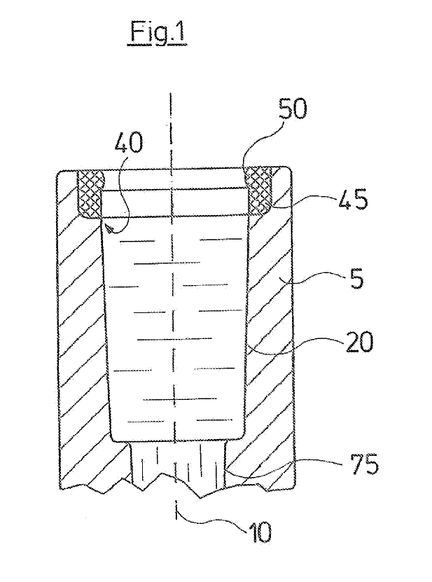

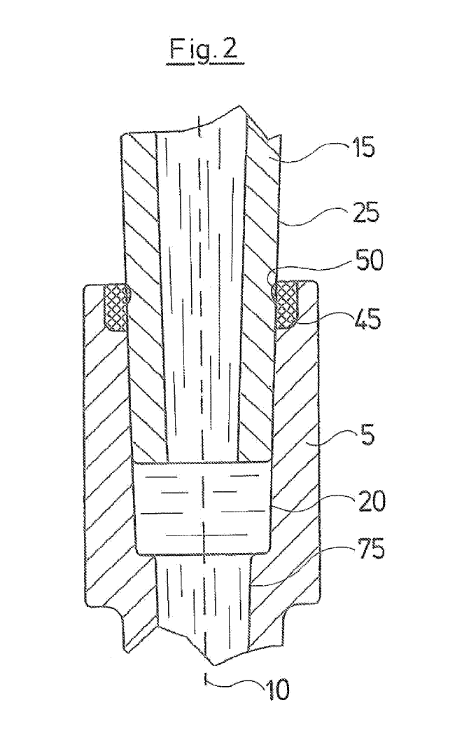

A connection part 5 represented in FIGS. 1 and 2 is designed as a female connection part. Thereby, the connection part 5 preferably has an essentially cylinder symmetry with respect to its longitudinal axis 10. The connection part 5 is thereby designed for connection to a standardized luer connection 15 as a counter-connection part. For this, the connection part 5 has a conical region 20, which in the shown preferred embodiment example forms a connection opening 20 for connection to the conical connection surface 25 of a standardized luer connection 15. The conical region 20 is designed as an inner cone 20, i.e. as a truncated-cone-like recess with an opening which widens in the direction of the free axial end 40 of the connection part 5. The conical surfaces 20 of the conical region 20 have a 6 percent gradient, so that the conical region 20 may come to bear in a surfaced manner with the conical connection surface 25 of the luer connection 15.

A seal 45 is preferably connected with a material fit at the free axial end 40 of the connection part 5, on the conical connection surface 20 of the connection part 5. The seal 45 is designed as a sealing ring 45 orientated coaxially to the inner cone. The seal 45 consists of thermoplastic elastomer, while the remaining connection part 5 is manufactured of thermoplastic plastic which is rigid at room temperature. Thereby, the seal 45 and the connection part 5 together are manufactured with the two-component injection molding method. The sealing element 45, for a suitable adaptation to the luer outer cone 25, preferably includes an inwardly projecting sealing contour which is designed as a sealing bead 50 and which, given a released connection, projects slightly into the conical opening region 20 of the connection piece 5. In this manner, the connection piece 5 always has a sealing contact with the outer cone 25 of the luer connection 15.

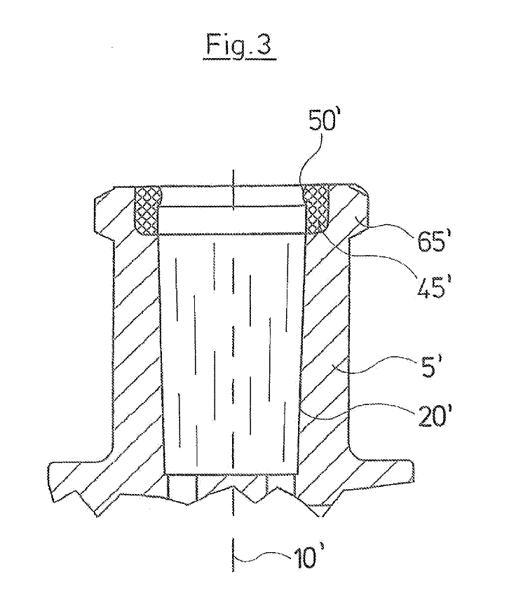

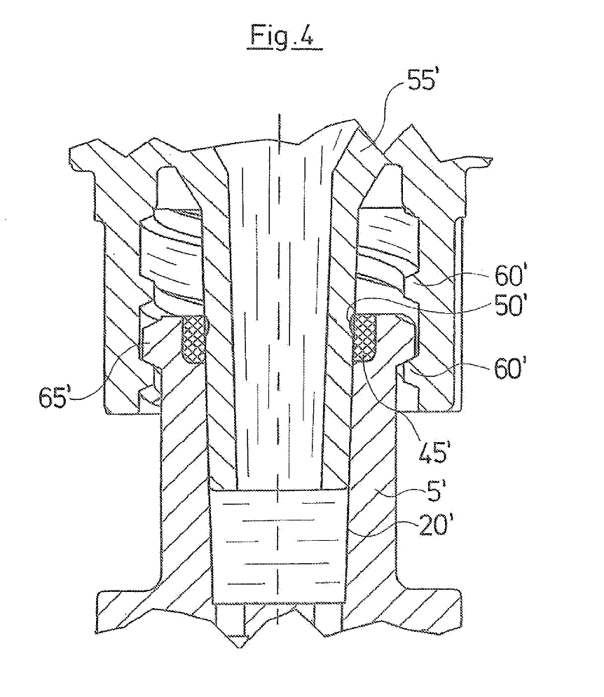

The connection part 5′ according to a preferred embodiment of the present invention, which is represented in FIGS. 3 and 4, is likewise designed as a female connection part 5′ and for the connection to a luer lock connection 55′. Thereby, the connection part 5′, inasmuch as it concerns the inner part, has the same features as the connection part 5 represented in FIGS. 1 and 2. Moreover, this connection part however has additional features for a lockable connection to the luer lock connection.

For locking, the luer lock connection 55′, as is known, comprises an inner thread 60′ which is arranged coaxially to the luer cone 25′ and surrounds this over the whole periphery. For locking with this inner thread 60′ of the luer lock connection 55′, the connection part 5′ is provided with two radial tongues for the threaded engagement 65′, which are envisaged for meshing with the thread 60′ of the luer lock connection 55′. These tongues 65′ are designed equally to those which serve for connection to a luer lock connection 55′ with a standardized luer connection. Thus, the tongues 65′ are arranged in an essentially diametrical manner. Thereby, the tongues 65′ are located at the free axial end 40′ of the connection part 5′, thus at that end on which the seal 45′ is fastened. The tongues 65′ thereby project outwards in the radial direction. Thus, the connection part 5′ may be screwed into the luer lock connection 55′, until an adequately tight bearing of the conical region 20′ or of the seal 45′ with the luer outer cone 25′ of the luer lock connection 55′ is achieved.

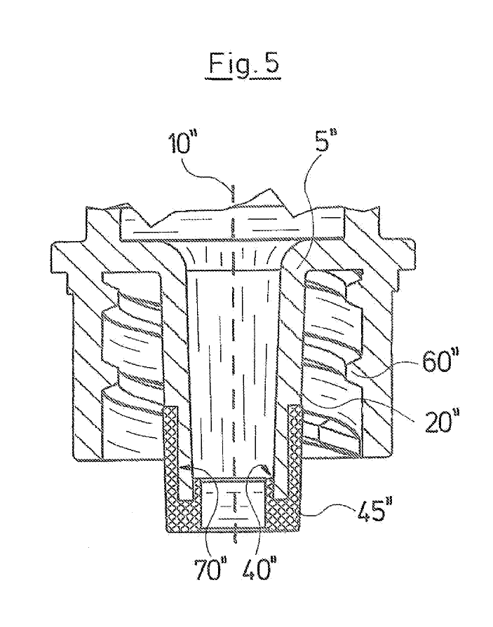

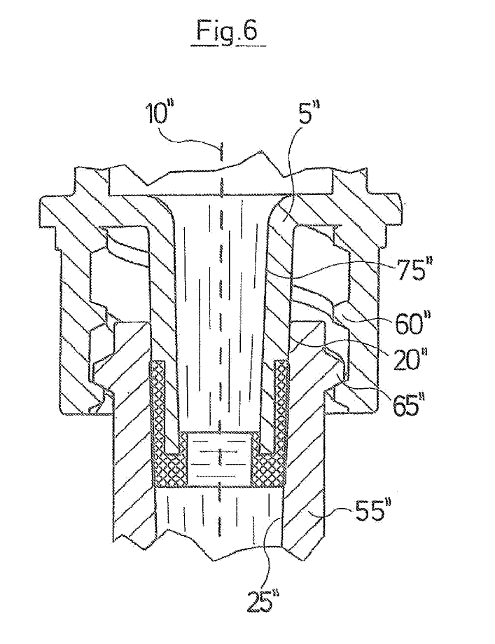

A further connection part 5″ according to a preferred embodiment of the present invention is represented in the FIGS. 5 and 6. This is designed as a male connection part 5″ and for connection to a female luer lock connection 55″. The connection part 5″, for connection to the luer lock connection 55″, preferably includes a conical region 20″. The conical region 20″ is designed as an outer cone 20″, i.e. it has a truncated-cone-like profile with a diameter tapering in the direction of the free axial end 40″ of the connection part 5″. This outer cone is thus designed fitting with an inner cone of a standardized female luer lock connection 55′, on which it may come to bear in a surfaced manner. A peripherally arranged ring seal 45″ is formed on the free axial end 40″ of the connection part 5″. For this reason, a slight axial overlap of the connection part 5″ with a female luer lock connection part 55″ is sufficient for a sealing bearing. The ring seal 45″ is attached on the axial end 40″ of the connection part 5″ in a manner such that the peripheral surface of the outer cone 20″ merges into the outer surface of the seal 45″ at the axial end 40″. For this, the outer cone 20″ at the axial end 40″ has a peripheral recess 70″, which extends up to the axial end 40″ and into which the material of the seal 45″ is deposited. The seal 45″ extends past the cross-sectional surface at the axial end 40″ of the cone-shaped region 20″, and projects slightly into the end region of the inner shank 75″ of the connection part 5″.

For locking with a female luer lock connection 55″, the connection piece 5″ comprises a coaxially orientated inner thread 60″ which peripherally surrounds the conical region 20″, with which inner thread 60″ corresponding tongues 65″ of the female luer lock connection 55′ may engage (see FIG. 6). This connection part 5″ too is manufactured as a single-part or single-piece component together with the seal 45″ as a two-component injection molded part.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-10. (canceled)

11. A connection part (5″) for connection to a standardized luer connection or luer lock connection (55″), which comprises a conical region (20″) for bearing on the conical connection surface (25″) of the standardized luer connection or luer lock connection (55″), wherein the connection part is a male connection part (5″), a seal (45″) is arranged on the conical region (20″) and the seal (45″) is designed as a sealing ring (45″) which is arranged over a whole periphery on the conical region (20″) and is arranged at a free axial end (40″) of the conical region (20″).

12. The connection part (5″) according to claim 11, wherein the seal (45″) is formed of a silicone rubber or a thermoplastic elastomer.

13. The connection part (5″) according to claim 11, wherein the seal (45″) is arranged with a material fit on the conical region (20″).

14. The connection part (5″) according to claim 11, wherein together with the seal (45″), the connection part is designed as a two-component injection molded part.

15. The connection part (5″) according to claim 11, wherein the connection part is part of a component with a return valve.

16. The connection part (5″) according to claim 11, wherein the connection part is part of a component designed as an injection molded part.
